(19) United States
(12) Patent Application Publication
(10) Pub. No.: US 2023/0163301 A1
(43) Pub. Date: May 25, 2023

(54) ALL-SOLID-STATE BATTERY

(71) Applicant: TDK CORPORATION, Tokyo (JP)

(72) Inventor: Takeo TSUKADA, Tokyo (JP)

(73) Assignee: TDK CORPORATION, Tokyo (JP)

(21) Appl. No.: 17/908,698

(22) PCT Filed: Jan. 5, 2021
(86) PCT No.: PCT/JP2021/000072

§ 371 Date: Sep. 1, 2022

(30) Foreign Application Priority Data
Mar. 6, 2020 (JP) 2020-039383

(51) Int. Cl. H01M 4/587

(52) U.S. Cl. CPC H01M 4/587; H01M 2004/021

(57) ABSTRACT

An all-solid-state battery including: a positive electrode layer that has a positive electrode current collector layer and a positive electrode active material layer; a negative electrode layer that has a negative electrode current collector layer and a negative electrode active material layer; and a solid electrolyte layer that contains a solid electrolyte, in which the positive electrode active material layer and the negative electrode active material layer each have a G-band full-width at half-maximum (G-FWHM) in a Raman spectrum of 40 (cm⁻¹) or less.

### TECHNICAL FIELD

The present invention relates to an all-solid-state battery.

Priority is claimed on Japanese Patent Application No. 2020-39383, filed Mar. 6, 2020, the content of which is incorporated herein by reference.

### BACKGROUND ART

In recent years, with the development of portable devices such as personal computers and mobile phones, the demand for batteries as a power source thereof has greatly increased. In a battery used for such usage, a liquid electrolyte (electrolytic solution) such as an organic solvent has been conventionally used as a medium for ionic migration. In a battery using such an electrolytic solution, there is probability of problems such as leakage of the electrolytic solution occurring.

In order to solve such problems, an all-solid-state battery in which a solid electrolyte is used instead of a liquid electrolyte and all other elements are constituted of solids is under development. Since the electrolyte of such an all-solid-state battery is solid, there is no concern about liquid leakage, liquid depletion, and the like, and problems such as a deterioration of battery performance due to corrosion are also unlikely to occur. Among them, all-solid-state batteries are being actively researched in various fields as secondary batteries readily enabling a high charge and discharge capacity and energy density.

However, an all-solid-state battery in which a solid electrolyte is used as an electrolyte still has a problem that the discharge capacity is generally smaller as compared to that of a battery in which a liquid electrolyte is used. In this regard, Li₃V₂(PO₄)₃ (hereinafter, LVP323), which is a NASICON-type phosphoric acid-based active material, has a plurality of oxidation-reduction potentials (3.8 V, 1.8 V), and in a symmetric electrode battery in which this is used for a positive electrode and a negative electrode, a 2 V class all-solid-state battery can be obtained. However, this LVP323 has a problem that the electron conductivity is lower, the internal resistance of the battery becomes higher, and the discharge capacity becomes smaller as compared to when LiCoO₂ is used as an active material. Therefore, in order to improve this electron conductivity, a plurality of conductive bodies oriented substantially perpendicular to a lamination direction are incorporated into an electrode layer or a current collector layer, thereby increasing the electron conductivity in a plane direction inside the electrode layer or the current collector layer. In particular, it is disclosed that carbon is incorporated as a current collector accompanied by firing out of concern for oxidation of metal (Patent Document 1).

### CITATION LIST

### Patent Literature

[Patent Document 1]
Japanese Patent No. 5804208

### SUMMARY OF INVENTION

### Technical Problem

However, even in the all-solid-state battery disclosed in Patent Document 1, there is still room for improvement in regard to the discharge capacity, and further reduction of the internal resistance of the all-solid-state battery is required.

The present invention has been made in view of the problems of the conventional art, and an object thereof is to provide an all-solid-state battery in which the internal resistance is further reduced.

### Solution to Problem

As a result of diligent studies to achieve the above-mentioned object, the inventor of the present invention found that, in an all-solid-state battery having a solid electrolyte layer between a pair of electrodes, by using carbon particles in which a G-band full-width at half-maximum (G-FWHM) in a Raman spectrum is 40 (m⁻¹) or less in a positive electrode active material layer and a negative electrode active material layer, the internal resistance of the battery can be reduced by adding a small amount thereof, and thereby completed the present invention.

That is, according to the present invention, the following all-solid-state battery is provided.

An all-solid-state battery according to one aspect of the present invention includes: a positive electrode layer that has a positive electrode current collector layer and a positive electrode active material layer; a negative electrode layer that has a negative electrode current collector layer and a negative electrode active material layer; and a solid electrolyte layer that contains a solid electrolyte, in which the positive electrode active material layer and the negative electrode active material layer contain carbon particles in which a G-band full-width at half-maximum (G-FWHM) in a Raman spectrum is 40 (m⁻¹) or less.

According to such a configuration, the internal resistance of the all-solid-state battery can be reduced. That is, carbon particles in which a G-band (peak near 1580 cm¹) full-width at half-maximum (G-FWHM) in a Raman spectrum is 40 (m⁻¹) or less have good crystallinity as a graphite structure and have small periodic disturbances, thereby having high heat stability, which enables them to be easily left in the electrode even when using a process accompanied by post-heat treatment such as sintering. Therefore, high electron conductivity is obtained with a small amount of addition, which enables a high-density electrode to be embodied. Furthermore, since these carbon particles have high crystallinity, electron conductivity is high. Therefore, by mixing the carbon particles and the active material to form an electrode, the electron conductivity of the electrode can be increased with a small amount of addition, which can reduce the internal resistance of the all-solid-state battery.

Furthermore, a small amount of voids may be generated in the vicinity of the carbon particles due to the evaporation of carbon by heat treatment or the like.

In the all-solid-state battery according to one aspect of the present invention, when a major axis of the carbon particles is a and a minor axis thereof is b, a ratio thereof may be 1.0<a/b.

According to such a configuration, by using the carbon particles having a small shape anisotropy, the active material can be densely filled together with active material particles, thereby making the contact area with the active material large, which makes smooth electron migration possible. Therefore, the electron conductivity in the electrode can be increased, which makes it possible to reduce the internal resistance of the all-solid-state battery.

In the all-solid-state battery according to one aspect of the present invention, in a particle size distribution of the carbon particles, D10 thereof may be 0.1 μm or more, and D90 may be 5.0 μm or less.

According to such configuration, the carbon particles can be brought into contact with the active material amount without excess and deficiency, and furthermore, the contact can be made without generating voids between the active materials, which makes the smooth electron exchange possible, and thereby the internal resistance of the all-solid-state battery can be reduced. Furthermore, when fine particles in which D10 is less than 0.1 μm are contained, the carbon particles are likely to evaporate while undergoing a process such as heat treatment, and a sufficient effect cannot be obtained.

In the all-solid-state battery according to one aspect of the present invention, the positive electrode active material layer and the negative electrode active material layer each may contain 0.5 (wt %) or more and 15.0 (wt %) or less of the carbon particles.

With the carbon particle content in such a configuration, because the contact between the carbon particles is sufficient, which can increase the electron conductivity as an electrode, and a substantial decrease in the active material amount can be prevented, a high capacity can be obtained while reducing the internal resistance of the all-solid-state battery.

### Advantageous Effects of Invention

According to the present invention, an all-solid-state battery in which the internal resistance is reduced can be provided.

### BRIEF DESCRIPTION OF DRAWINGS

FIG. 1 is a cross-sectional view of an all-solid-state battery of the present embodiment.

### DESCRIPTION OF EMBODIMENTS

Hereinafter, suitable embodiments of the present invention will be described in detail with reference to the drawings. In the drawings, the same or corresponding parts are designated by the same reference numerals, and duplicate description will be omitted. Furthermore, the dimensional ratios in the drawings are not limited to the ratios shown in the drawings. In the drawings used in the following description, characteristic portions may be shown by enlarging them for convenience to facilitate understanding the characteristics of the present invention. Therefore, the dimensional ratios and the like of each of constituent elements shown in the drawings may differ from those of the actual ones. The materials, dimensions, shapes, and the like exemplified in the following description are exemplary examples, and the present invention is not limited to these and can be implemented by being appropriately changed within the range in which the gist thereof is not changed and the effect is exhibited. For example, the configurations described in different embodiments and the configurations described in examples can be implemented by being appropriately combined. In the present embodiment, one direction in a lamination direction may be referred to as an upward direction or a downward direction, but the upward and the downward referred to herein do not necessarily match the direction in which gravity is applied.

(All-Solid-State Battery)

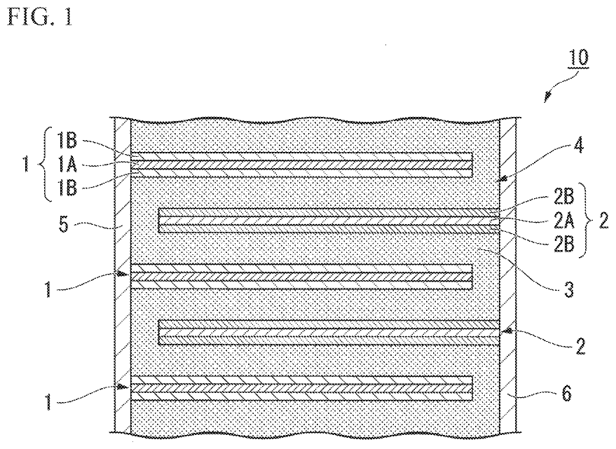

FIG. 1 is a schematic cross-sectional view showing a structure for explaining the concept of an all-solid-state battery 10 of the present embodiment. As shown in FIG. 1, the all-solid-state battery 10 of the present embodiment has at least one positive electrode layer 1, at least one negative electrode layer 2, and a solid electrolyte 3 in which at least a part thereof is sandwiched between the positive electrode layer 1 and the negative electrode layer 2. The positive electrode layer 1 and the negative electrode layer 2 are laminated in order via the solid electrolyte layer 3 to constitute a laminate 4. Each of the positive electrode layers 1 is connected to a terminal electrode 5 disposed on one end side, and each of the negative electrode layers 2 is connected to a terminal electrode 6 disposed on the other end side.

The positive electrode layer 1 is an example of a first electrode layer, and the negative electrode layer 2 is an example of a second electrode layer. One of the first electrode layer and the second electrode layer functions as a positive electrode, and the other functions as a negative electrode. The positive and negative of the electrode layers changes depending on which polarity is connected to the terminal electrodes 5 and 6.

The positive electrode layer 1 has a positive electrode current collector layer 1A, and a positive electrode active material layer 1B formed on one side or both sides of the positive electrode current collector layer 1A. The positive electrode active material layer 1B may not be provided on the surface of the positive electrode current collector layer 1A on the side towards which the facing negative electrode layer 2 is not present. The negative electrode layer 2 has a negative electrode current collector layer 2A, and a negative electrode active material layer 2B formed on one side or both sides of the negative electrode current collector layer 2A. The negative electrode active material layer 2B may not be provided on the surface of the negative electrode current collector layer 2A on the side towards which the facing positive electrode layer 1 is not present. For example, the positive electrode layer 1 or the negative electrode layer 2 located at the uppermost layer or the lowermost layer of the laminate 4 may not have the positive electrode active material layer 1B or the negative electrode active material layer 2B on one side thereof.

The all-solid-state battery 10 according to the present embodiment is an all-solid-state battery having the solid electrolyte layer 3 between a pair of electrode layers, and the positive electrode active material layer 1B and the negative electrode active material layer 2B included in the pair of electrode layers contains carbon particles in which a G-band full-width at half-maximum (G-FWHM) in a Raman spectrum is 40 (m⁻¹) or less. Furthermore, it is preferable to incorporate carbon particles in which the G-band full-width at half-maximum (G-FWHM) in the Raman spectrum is 24 (m⁻¹) or less.

According to such a configuration, the internal resistance of the all-solid-state battery 10 can be reduced. That is, the carbon particles in which the G-band (peak near 1580 cm⁻¹) full-width at half-maximum (G-FWHM) in the Raman spectrum is 40 (m⁻¹) or less have good crystallinity as a graphite structure and have small periodic disturbances, thereby having high heat stability, which enables them to be easily left in the electrode even when using a process accompanied by post-heat treatment such as sintering. Therefore, high electron conductivity is obtained with a small amount of addition, which enables a high-density electrode to be embodied. Furthermore, since these carbon particles have high crystallinity, electron conductivity is high. Therefore, by mixing the carbon particles and the active material to form an electrode, the electron conductivity of the electrode can be increased with a small amount of addition, which can reduce the internal resistance of the all-solid-state battery 10.

Furthermore, a small amount of voids may be generated in the vicinity of each of the carbon particles due to the evaporation of carbon by heat treatment or the like.

The G-band full-width at half-maximum of the Raman spectrum of the carbon particles of the present embodiment can be calculated from the full-width at half-maximum of the peak appearing near 1580 cm⁻¹ at the excitation wavelength of 532 nm using a micro-laser Raman spectrometer (device name: NRS-7100, manufactured by JASCO Corporation), for example.

The positive electrode active material layer 1B and the negative electrode active material layer 2B of the all-solid-state battery 10 according to the present embodiment preferably further contain carbon particles in which when a major axis of the particles is a and a minor axis thereof is b, a ratio thereof is 1.0<a/b.

According to such a configuration, by using the carbon particles having a small shape anisotropy, the active material can be densely filled together with active material particles, thereby making the contact area with the active material large, which makes smooth electron migration possible. Therefore, the electron conductivity in the electrode is increased, which makes it possible to reduce the internal resistance of the all-solid-state battery 10.

The positive electrode active material layer 1B and the negative electrode active material layer 2B of the all-solid-state battery 10 according to the present embodiment preferably further contain carbon particles in which in a particle size distribution, D10 thereof is 0.1 μm or more, and D90 is 5.0 μm or less. D10 is the diameter of particles having the cumulative volume of 10% by volume in the distribution curve obtained by particle size distribution measurement of the circle-equivalent diameter calculated based on the area data of the carbon particles. Furthermore, D90 is the diameter of particles having the cumulative volume of 90% by volume in the distribution curve obtained by particle size distribution measurement.

According to such configuration, the carbon particles can be brought into contact with the active material without excess and deficiency, and furthermore, the contact can be made without generating voids between the active materials, which makes the smooth electron exchange possible, and thereby the internal resistance of the all-solid-state battery 10 can be reduced. Furthermore, when fine particles in which D10 is less than 0.1 μm are not contained, the carbon particles are prevented from evaporating while undergoing a process such as heat treatment, and thereby a sufficient effect is guaranteed.

The positive electrode active material layer 1B and the negative electrode active material layer 2B of the all-solid-state battery 10 according to the present embodiment each preferably contain 0.5 (wt %) or more and 15.0 (wt %) or less of the carbon particles.

According to the carbon particle content in such a configuration, because the contact between the carbon particles is sufficient, which can increase the electron conductivity as an electrode, and a substantial decrease in the active material amount can be prevented, a high capacity can be obtained while reducing the internal resistance of the all-solid-state battery 10.

(Carbon Particles)

The carbon particles of the present embodiment may have the G-band (peak near 1580 cm⁻¹) full-width at half-maximum (G-FWHM) in the Raman spectrum of 40 (m⁻¹) or less, and may be an artificial synthetic product or a natural mineral.

(Solid Electrolyte)

At least a part of the solid electrolyte layer 3 is sandwiched between the positive electrode layer 1 and the negative electrode layer 2. As shown in FIG. 1, at least a part of the solid electrolyte layer 3 may be located in the in-plane direction of the positive electrode layer 1 and the negative electrode layer 2.

For a solid electrolyte in the solid electrolyte layer 3, a material having ionic conductivity and a negligibly small electron conductivity is used, for example.

Examples of the solid electrolyte include lithium halides, lithium nitrides, lithium oxyacid salts, and derivatives thereof. Examples thereof further include Li—P—O-based compounds such as lithium phosphate (Li₃PO₄), LIPON (LiPO₄₋ₓNₓ) in which nitrogen is mixed to lithium phosphate, Li—Si—O-based compounds such as Li₄SiO₄, Li—P—Si—O-based compounds, Li—VSi—O-based compounds, perovskite compounds such as La_{0.51}Li_{0.35}TiO_{2.94}, La_{0.55}Li_{0.35}TiO₃, and Li₃ₓLa_{2/3-x}TiO₃ which have a perovskite structure, and compounds having a garnet structure having Li, La, or Zr, where it is particularly preferable to incorporate a compound having a NASICON structure. The composition of the compound having the NASICON structure is represented by LiₓM_{y}(PO₄)₃ (including x=1 to 2, y=1 to 2, M=at least one of Ti, Ge, Al, Ga, or Zr), where a part of P may be substituted with B, Si, or the like. Examples of the compound having the NASICON structure include Li_{1.3}Al_{0.3}Ti_{1.7}(PO₄)₃ and Li_{1.5}Al_{0.5}Ge_{1.5}(PO₄)₃.

(Negative Electrode Active Material)

The negative electrode active material layer 2B has a negative electrode active material. As the negative electrode active material, an oxide of at least one element selected from the group consisting of Li₄Ti₅O₁₂, Ti, Nb, W, Si, Sn, Cr, Fe, and Mo, phosphorus-containing compounds such as Li₃V₂(PO₄)₃ and LiFePO₄, or the like may be used.

(Positive Electrode Active Material)

The positive electrode active material layer 1B has a positive electrode active material. As the positive electrode active material, layered compounds such as LiCoO₂, LiCo_{1/3}Ni_{1/3}Mn_{1/3}O₂, spinel materials such as LiMn₂O₄ and LiNi_{0.5}Mn_{1.5}O₄, phosphorus-containing compounds such as Li₃V₂(PO₄)₃ and LiFePO₄, or the like may be used. When the carbon material of the present invention is contained in at least one of the positive electrode active material and the negative electrode active material, the effect of the present invention can be exerted.

There is no clear distinction between active materials constituting the positive electrode active material layer 1B or the negative electrode active material layer 2B, and by comparing the potentials of two types of compounds, which are a compound in the positive electrode active material layer 1B and a compound in the negative electrode active material layer 2B, a compound showing a more noble potential can be used as the positive electrode active material, and a compound showing a lower potential can be used as the negative electrode active material. Furthermore, as long as it is a compound having both a lithium ion desorbing function and a lithium ion absorbing function, the same material may be used as the active material constituting the positive electrode active material layer 1B and the negative electrode active material layer 2B. When the same material is used as the active material constituting the positive electrode active material layer 1B and the negative electrode active material layer 2B, a non-polar all-solid-state battery can be obtained, for which a direction when being mounting on a circuit board is not required to be specified, thereby making it possible to facilitate the mountability.

(Current Collector)

As the material constituting the positive electrode current collector layer 1A and the negative electrode current collector layer 2A, it is preferable to use a material having a high electrical conductivity, and for example, it is preferable to use silver, palladium, gold, platinum, aluminum, copper, nickel, or the like. In particular, copper is preferable because it is unlikely to react with lithium aluminum titanium phosphate and is effective in reducing the internal resistance of the all-solid-state battery. The material constituting the current collector layer may be the same as that of the positive electrode layer 1 and the negative electrode layer 2, or may be different therefrom.

Furthermore, it is preferable that the positive electrode current collector layer 1A and the negative electrode current collector layer 2A of the all-solid-state battery in the present embodiment contain a positive electrode active material and a negative electrode active material, respectively.

When the positive electrode current collector layer 1A and the negative electrode current collector layer 2A contain the positive electrode active material 1B and the negative electrode active material 2B, respectively, this is desirable because then the adhesiveness between the positive electrode current collector layer 1A and the positive electrode active material layer 1B, and the adhesiveness between the negative electrode current collector layer 2A and the negative electrode active material layer 2B are improved.

(Terminal Electrode)

The terminal electrodes 5 and 6 are formed to be in contact with the side surface of a sintered body. The terminal electrodes 5 and 6 are connected to external terminals and are responsible for sending and receiving electrons to and from the sintered body.

It is preferable to use a material having a high electrical conductivity for the terminal electrodes 5 and 6. For example, silver, gold, platinum, aluminum, copper, tin, nickel, gallium, indium, and alloys thereof can be used.

(Method for Manufacturing all-Solid-State Battery)

In a method for manufacturing the all-solid-state battery of the present embodiment, first, each material of the positive electrode current collector layer, the positive electrode active material layer, the solid electrolyte layer, the negative electrode active material layer, and the negative electrode current collector layer is made into a paste, which is applied and dried to produce green sheets (first step). Subsequently, such green sheets are laminated to produce a laminate (second step). Subsequently, the produced laminate is fired to manufacture (third step).

(First Step)

First, the positive electrode active material and the negative electrode active material, and the carbon material are prepared. At this time, when the active material contains compounds of two or more types of elements, a mixed material in which the compounds of each element are mixed may be prepared. Furthermore, also when a solid electrolyte is mixed in the active material, a mixed material may be prepared.

A method for producing pastes for the positive electrode active material layer and the negative electrode active material layer is not particularly limited, and for example, the pastes can be obtained by mixing the positive electrode active material and the negative electrode active material, and the carbon material with a vehicle. Herein, the vehicle is a generic term for a medium in a liquid phase. The vehicle includes a solvent and a binder. By such a method, a paste for the positive electrode current collector layer, a paste for the positive electrode active material layer, a paste for the solid electrolyte layer, a paste for the negative electrode active material layer, and a paste for the negative electrode current collector layer are produced.

The produced pastes are applied onto a substrate such as PET in a desired order, and dried as necessary, and thereafter the substrate is peeled off to produce green sheets. A method of applying the pastes is not particularly limited, and known methods such as screen printing, application, transfer, and doctor blade can be adopted.

(Second Step)

The produced green sheets are stacked in a desired order and a desired number of lamination layers, and as necessary, alignment, cutting, and the like are performed to produce a laminate. When producing a parallel type or series-parallel type battery, it is preferable to stack by performing alignment such that the edge surface of the positive electrode layer and the edge surface of the negative electrode layer do not match.

When producing the laminate, an active material layer unit described below may be prepared to produce the laminate.

A method thereof is as follows: first, the paste for the solid electrolyte layer is formed in the sheet shape on a PET film by a doctor blade method to obtain a solid electrolyte sheet, and thereafter the paste for the positive electrode active material layer is printed on this solid electrolyte sheet by screen printing and dried. Subsequently, the paste for the positive electrode current collector layer is printed thereon by screen printing and dried. Furthermore, the paste for the positive electrode active material layer is printed thereon again by screen printing and dried, and subsequently, the PET film is peeled off to obtain a positive electrode active material layer unit. In this manner, the positive electrode active material layer unit in which the paste for the positive electrode active material layer, the paste for the positive electrode current collector layer, and the paste for the positive electrode active material layer are formed in this order on the solid electrolyte sheet is obtained. A negative electrode active material layer unit is also produced by the same procedure, and the negative electrode active material layer unit in which the paste for the negative electrode active material layer, the paste for the negative electrode current collector layer, and the paste for the negative electrode active material layer are formed in this order on the solid electrolyte sheet is obtained.

One sheet of the positive electrode active material layer unit and one sheet of the negative electrode active material layer unit are stacked with the solid electrolyte sheet therebetween. At this time, the units are each stacked so as not to match each other such that the paste for the positive electrode current collector layer of the first sheet of the positive electrode active material layer unit extends only to one edge surface, and the paste for the negative electrode current collector layer of the second sheet of the negative electrode active material layer unit extends only to the other surface. Solid electrolyte sheets having a predetermined thickness are further stacked on both sides of these stacked units to produce a laminate.

The produced laminate is collectively pressure-bonded. The pressure bonding is performed while heating, and the heating temperature is 40° C. to 95° C., for example.

(Third Step)

The pressure-bonded laminate is heated to 600° C. to 1100° C. in a nitrogen atmosphere, for example to perform firing. The firing time is 0.1 to 3 hours, for example. This firing completes a sintered body.

Furthermore, terminal electrodes can be provided to efficiently draw a current from the sintered body. The terminal electrodes are respectively connected to one end of the positive electrode layer extending to one side surface of the sintered body, and one end of the negative electrode layer extending to one side surface of the sintered body. Accordingly, a pair of the terminal electrodes are formed so as to sandwich one side surface of the sintered body. Examples of methods of forming the terminal electrodes include a sputtering method, a screen printing method, and a dip coating method. In the screen printing method and the dip coating method, a paste for terminal electrodes containing a metal powder, a resin, and a solvent is produced and formed as the terminal electrodes. Subsequently, a baking step for removing the solvent, and plating treatment for protection and for mounting on the surface of the terminal electrodes are performed. On the other hand, in the sputtering method, a baking step and a plating treatment step are unnecessary because a protective layer and a layer for mounting can be formed on the terminal electrodes.

The all-solid-state battery can be manufactured by going through the steps as above.

The present invention is not necessarily limited to the above-mentioned embodiment, and various changes can be added within the range not departing from the spirit of the present invention. That is, each configuration and the combination thereof, and the like in the above-mentioned embodiment are merely examples, and addition, omission, replacement, and other changes of the configuration can be added within the range not departing from the spirit of the present invention.

### EXAMPLES

### Examples 1 to 4

The contents of the present invention will be described in more detail with reference to examples and comparative examples, but the present invention is not limited to the following examples.

(Production of Positive Electrode Active Material)

Li₃V₂(PO₄)₃ was used as the active material to verify the effect of the present embodiment. For starting materials, LiPO₃ and V₂O₃ were used, and after weighing the starting materials, mixing and pulverizing were performed in ethanol with a ball mill (120 rpm/zirconia balls) for 16 hours. The mixed powder of the starting materials was separated from the balls and ethanol and dried, and thereafter calcination was performed using a magnesia crucible. The calcination was performed at 950° C. for 2 hours in a reducing atmosphere, and thereafter the calcined powder was treated in ethanol with a ball mill (120 rpm/zirconia balls) for 16 hours for pulverization. The pulverized powder was separated from the balls and ethanol and dried, and thereafter a Li₃V₂(PO₄)₃ powder was obtained.

(Production of Negative Electrode Active Material)

As the negative electrode active material, the same powder as that of the positive electrode active material was used.

(Production of Solid Electrolyte)

As the solid electrolyte, Li_{1.3}Al_{0.3}Ti_{1.7}(PO₄)₃ produced by the following method was used. Using Li₂CO₃, Al₂O₃, TiO₂, and NH₄H₂PO₄ as starting materials, wet-type mixing was performed in ethanol as a solvent with a ball mill for 16 hours. The mixed powder of the starting materials was separated from the balls and ethanol and dried, and thereafter calcination was performed in an alumina crucible at 850° C. for 2 hours in the atmosphere. Thereafter, the calcined powder was treated in ethanol with a ball mill (120 rpm/zirconia ball) for 16 hours for pulverization. The pulverized powder was separated from the balls and ethanol and dried to obtain a powder.

(Mixing of Active Material and Carbon Material)

As Examples 1 to 4, carbon materials in which D10 was 0.25 μm and D90 was 4.5 μm, the a/b was 3, and the G-band full-widths at half-maximum (G-FWHM) were respectively 10, 18, 24, and 39 (cm⁻¹)) were used to verify the effect of the present embodiment. Furthermore, Li₃V₂(PO₄)₃ described above was used as an active material. First, the carbon materials having each G-band full-width at half-maximum (G-FWHM) were weighed so that they were 10.7, 11.3, 12.6, and 13.5 (wt %) with respect to Li₃V₂(PO₄)₃, and mixing was performed in an organic solvent using a ball mill. The powder was separated from the balls and the organic solvent and dried to obtain a mixed powder of the carbon material and Li₃V₂(PO₄)₃. Herein, the carbon materials added with respect to Li₃V₂(PO₄)₃ are described in the tables as the charged addition amount.

(Production of Paste for Positive Electrode Active Material Layer and Paste for Negative Electrode Active Material Layer)

For pastes for positive and negative electrode active material layers, 15 parts of ethyl cellulose as a binder and 65 parts of dihydroterpineol as a solvent were added to 100 parts of the above-mentioned mixed powder of the carbon material and Li₃V₂(PO₄)₃, and the mixture was kneaded and dispersed with three rolls to produce pastes for active material layers serving as a positive electrode and a negative electrode.

(Production of Paste for Solid Electrolyte Layer)

As a solid electrolyte, the above-mentioned Li_{1.3}Al_{0.3}Ti_{1.7}(PO₄)₃ powder was used. 100 parts of ethanol and 200 parts of toluene as a solvent were added to 100 parts of this powder by a ball mill to perform wet-type mixing. Thereafter, 16 parts of a polyvinyl butyral-based binder and 4.8 parts of benzyl butyl phthalate were further injected and mixed to compound a paste for a solid electrolyte layer.

(Production of Sheet for Solid Electrolyte Layer)

This paste for a solid electrolyte layer was sheet-formed using a PET film as a substrate by a doctor blade method to obtain a sheet for a solid electrolyte layer having a thickness of 15 μm.

(Production of Paste for Positive Electrode Current Collector Layer and Paste for Negative Electrode Current Collector Layer)

After mixing a Cu powder and a Li₃V₂(PO₄)₃ powder such that the weight ratio was 100:9, 10 parts of ethyl cellulose as a binder and 50 parts of dihydroterpineol as a solvent were added, and mixed and dispersed with three rolls to produce a paste for a positive electrode current collector layer and a paste for a negative electrode current collector layer.

(Production of Terminal Electrode Paste)

A Cu powder, a glass powder, an acrylic resin, and terpineol were mixed and dispersed to produce a Cu terminal electrode paste.

(Production of Active Material Layer Unit)

The paste for an electrode current collector layer was printed on the above-mentioned sheet for a solid electrolyte layer to the thickness of 5 μm by screen printing, and dried at 80° C. for 10 minutes. The paste for a positive electrode active material layer was printed thereon to the thickness of 5 μm by screen printing, and dried at 80° C. for 10 minutes to obtain a positive electrode layer unit. Meanwhile, the paste for a negative electrode active material layer was printed on the sheet for a solid electrolyte layer to the thickness of 5 μm by screen printing, and dried at 80° C. for 10 minutes, and subsequently, the paste for an electrode current collector layer was printed thereon to the thickness of 5 μm by screen printing, and dried at 80° C. for 10 minutes to obtain a negative electrode layer unit. Subsequently, the PET film was peeled off.

(Production of Laminate)

Using the positive electrode layer unit, the negative electrode layer unit, and the sheet for a solid electrolyte layer, a laminate was obtained by stacking such that the formation was in the order of the solid electrolyte layer, the positive electrode current collector layer, the positive electrode active material layer, the solid electrolyte layer, the negative electrode active material layer, the negative electrode current collector layer, and the solid electrolyte layer. At this time, the units were each stacked so as not to match each other such that the positive electrode current collector layer of the positive electrode layer unit extended only to one edge surface, and the negative electrode current collector layer of the negative electrode active layer unit extended only to the other edge surface. Thereafter, this was formed by thermal compression bonding, and then cut to produce the laminate.

(Production of Sintered Body)

After the obtained laminate was subjected to debinding, co-firing was performed to obtain a sintered body. For the debinding, the temperature was raised to the firing temperature of 700° C. at 50° C./hour in nitrogen, and this temperature was maintained for 10 hours; and for the co-firing, the temperature was raised to the firing temperature of 850° C. at the temperature rising rate of 200° C./hour in nitrogen, this temperature was maintained for 1 hour, and natural cooling was performed after the firing.

Furthermore, it was confirmed that the residual carbon content in the electrode active material layer region of the obtained sintered body was substantially 10 (wt %).

(Production of Terminal Electrodes)

The Cu terminal electrode paste was applied to the edge surface of the above-mentioned sintered body, and heat treatment was performed at 600° C. for 15 minutes in an N₂ atmosphere to form a pair of terminal electrodes. In this manner, an all-solid-state battery was completed.

(Evaluation of G-Band Full-Width at Half-Maximum (G-FWHM) of Raman Spectrum of Carbon Particles in Electrode Active Material Layers)

The electrode active material layer region of the obtained sintered body was exposed by polishing or the like and processed smoothly, and using a micro-laser Raman spectrometer (device name: NRS-7100, manufactured by JASCO Corporation), the Raman spectrum was measured to calculate from the full-width at half-maximum of the peak appearing near 1580 cm⁻¹ at the excitation wavelength of 532 nm.

(Evaluation of Major Axis a and Minor Axis b of Carbon Particles in Electrode Active Materials)

The electrode active material layer region of the obtained sintered body was exposed by polishing or the like and processed smoothly, and for about 100 or more carbon particles in the visual field from the observation with a scanning electron microscope (SEM), the length in the longest axial direction of each of the carbon particles was defined as a, and the length in the shortest axial direction thereof was defined as b, and thereby the ratio thereof could be calculated as the a/b. For magnification in the SEM, magnification was selected by selecting an appropriate value according to the particle size of the carbon particles such that 100 or more and 300 or less particles were observed in the visual field, and the a/b ratio of all carbon particles in the visual field was obtained to calculate the average.

(Evaluation of Particle Size Distribution of Carbon Particles in Electrode Active Material Layers)

The electrode active material layer region of the obtained sintered body was exposed by polishing or the like and processed smoothly, and for about 200 or more particles in the visual field from the observation with a scanning electron microscope (SEM), the area of each particle was measured using image processing. The circle-equivalent diameter was calculated from the area data to define the particle size at a cumulative volume of 10% by volume as D10, and define the particle size at a cumulative volume of 90% by volume as D90.

(Evaluation of Carbon Content in Electrode Active Material Layers)

The electrode active material layer region of the obtained sintered body was separated and pulverized to measure using a combustion in oxygen stream-infrared absorption method with a Carbon Sulfur Analyzer (manufactured by LECO Japan Corporation, device name: CS-844) as an analyzer.

(Measurement of Relative Density)

The external dimensions of the obtained sintered body were measured to calculate the volume, and the weight of the sintered body was divided by the volume to obtain the density of the sintered body. Meanwhile, the theoretical density was obtained using the shape and dimensions and the specific gravity of each of the constituting portions of the sintered body. Specifically, first, the dimensions of each of the constituting portions of the sintered body were calculated to obtain the theoretical density. Herein, each of the constituting portions of the sintered body is a portion of the solid electrolyte layer, a portion of the positive electrode active material layer, a portion of the positive electrode current collector layer, a portion of the negative electrode active material layer, and a portion of the negative electrode current collector layer. Subsequently, the volume of each of the constituting portions was calculated from the shape and dimensions of each of the constituting portions of the solid electrolyte layer. Subsequently, the specific gravity of each of the constituting portions of the solid electrolyte layer was multiplied by the calculated volume. As the specific density of each of the constituting portions, a known specific gravity was utilized. Subsequently, these were summed to calculate the weight of the sintered body. For the positive electrode active material and the negative electrode active material having the active material and carbon, the calculation was performed in consideration of the abundance ratio. Subsequently, the calculated weight of the sintered body was divided by the volume of the sintered body to obtain the theoretical density. The ratio of the density of the sintered body obtained thereafter and the theoretical density was taken as the relative density. The relative density was obtained by (density of sintered body/theoretical density).

(Evaluation of Impedance)

The obtained laminate was installed to a holding device of a type fixing with a spring attachment pin to measure the internal resistance thereof using an Impedance/Gain-Phase analyzer (manufactured by Solartron Analytical, device name: 1260A). The measurement was performed at the measurement frequency of 0.005 Hz, and the alternating current applied voltage of 0.05 V. The values of the obtained internal resistance are shown in Table 1. The case in which the value of the internal resistance was smaller than 1×10⁷ (Ω) was regarded as being favorable.

(Evaluation of Charge and Discharge Characteristics)

Furthermore, the obtained laminate was installed to a holding device of a type fixing with a spring attachment pin to measure the charge and discharge capacity using a charge and discharge tester. The measurement was performed at the current at the time of charging and discharging of 2 μA in all the cases, and the voltage of 0 V to 1.6 V as the measurement conditions. Table 1 shows the measured discharge capacities. The case in which the value of the discharge characteristic was larger than 1.5 μAh was regarded as being favorable.

### Comparative Example 1

In the present comparative example, a carbon material in which D10 was 0.25 μn and D90 was 4.5 μm, the a/b was 3, and G-FWHM was 43 (cm⁻¹) was used. In addition, the above-mentioned Li₃V₂(PO₄)₃ powder was used as an active material.

This carbon material was weighed so that it was 16.3 (wt %) with respect to Li₃V₂(PO₄)₃, and mixing was performed in an organic solvent using a ball mill. The powder was separated from the balls and the organic solvent and dried to obtain a mixed powder of the carbon material and Li₃V₂(PO₄)₃. Furthermore, after producing a laminate using the same method as in Example 1, debinding and sintering were performed by the same method. The discharge characteristics of this laminate were evaluated by the same method as in Example 1. Table 1 shows the values of the measured internal resistance, and discharge capacities.

As can be found also from Table 1, by using the carbon material and the active material in the range according to the present invention for the active material layer, an effective residual amount could be incorporated even with a small amount of addition, which enabled a dense electrode portion to be realized, and thereby a clearly low internal resistance as the all-solid-state battery was shown. It was also found that a high discharge capacity was obtained.

TABLE 1

| | | | | | Charged | | | | |
|---|---|---|---|---|---|---|---|---|---|
| | G- | | | | addition | Residual | | Discharge | Relative |
| | FWHM | D10 | D90 | a/b | amount | content | Imp (Ω) at | capacity | density |
| | (cm⁻¹) | (μm) | (μm) | ratio | (Wt %) | (Wt %) | 0.005 Hz | (μAh) | (%) |
| Example 1 | 10 | 0.25 | 4.5 | 3.0 | 10.7 | 10 | 5.25 × 10⁵ | 6.05 | 97.88 |
| Example 2 | 18 | 0.25 | 4.5 | 3.0 | 11.3 | 10 | 5.15 × 10⁵ | 8.15 | 96.65 |
| Example 3 | 24 | 0.25 | 4.5 | 3.0 | 12.6 | 10 | 2.99 × 10⁶ | 4.53 | 93.45 |
| Example 4 | 39 | 0.25 | 4.5 | 3.0 | 13.5 | 10 | 3.91 × 10⁶ | 3.85 | 87.59 |
| Comparative | 43 | 0.25 | 4.5 | 3.0 | 16.3 | 10 | 1.03 × 10⁷ | 1.18 | 85.10 |
| Example 1 | | | | | | | | | |

### Examples 5 to 12

(Mixing of Active Material and Carbon Material)

As Examples 5 to 12, carbon materials in which D10 was 0.25 μm and D90 was 4.5 μm, G-FWHM was 18 (cm⁻¹), and the a/b's were respectively 1.0, 1.1, 1.5, 5.0, 10.0, 50.0, 100.0, and 200.0 were used to verify the effect of the present embodiment. Furthermore, the above-mentioned Li₃V₂(PO₄)₃ powder was used as an active material. The carbon material was weighed so that it was 11.3 wt % with respect to Li₃V₂(PO₄)₃, and mixing was performed in an organic solvent using a ball mill. The powder was separated from the balls and the organic solvent and dried to obtain a mixed powder of the carbon material and Li₃V₂(PO₄)₃.

(Production of Paste for Positive Electrode Active Material Layer and Paste for Negative Electrode Active Material Layer)

For pastes for positive and negative electrode active material layers, 15 parts of ethyl cellulose as a binder and 65 parts of dihydroterpineol as a solvent were added to 100 parts of the above-mentioned mixed powder of the carbon material and Li₃V₂(PO₄)₃, and the mixture was kneaded and dispersed with three rolls to produce pastes for active material layers serving as a positive electrode and a negative electrode.

(Production of Paste for Solid Electrolyte Layer)

As a solid electrolyte, the above-mentioned Li_{1.3}Al_{0.3}Ti_{1.7}(PO₄)₃ powder was used. 100 parts of ethanol and 200 parts of toluene as a solvent were added to 100 parts of this powder by a ball mill to perform wet-type mixing. Thereafter, 16 parts of a polyvinyl butyral-based binder and 4.8 parts of benzyl butyl phthalate were further injected and mixed to compound a paste for a solid electrolyte layer.

(Production of Sheet for Solid Electrolyte Layer)

This paste for a solid electrolyte layer was sheet-formed using a PET film as a substrate by a doctor blade method to obtain a sheet for a solid electrolyte layer having a thickness of 15 μm.

(Production of Paste for Positive Electrode Current Collector Layer and Paste for Negative Electrode Current Collector Layer)

After mixing a Cu powder and a Li₃V₂(PO₄)₃ powder such that the weight ratio was 100:9, 10 parts of ethyl cellulose as a binder and 50 parts of dihydroterpineol as a solvent were added, and mixed and dispersed with three rolls to produce a paste for a positive electrode current collector layer and a paste for a negative electrode current collector layer.

(Production of Terminal Electrode Paste)

A silver powder, an epoxy resin, and a solvent were mixed and dispersed to produce a heat-curable type terminal electrode paste.

(Production of Active Material Layer Unit)

The paste for a positive electrode current collector layer was printed on the above-mentioned sheet for a solid electrolyte layer to the thickness of 5 μm by screen printing, and dried at 80° C. for 10 minutes. The paste for a positive electrode active material layer was printed thereon to the thickness of 5 μm by screen printing, and dried at 80° C. for 10 minutes to obtain a positive electrode layer unit. Meanwhile, the paste for a negative electrode active material layer was printed on the sheet for a solid electrolyte layer to the thickness of 5 μm by screen printing, and dried at 80° C. for 10 minutes, and subsequently, the paste for an negative electrode current collector layer was printed thereon to the thickness of 5 μm by screen printing, and dried at 80° C. for 10 minutes to obtain a negative electrode layer unit. Subsequently, the PET film was peeled off.

(Production of Laminate)

Using the positive electrode layer unit, the negative electrode layer unit, and the sheet for a solid electrolyte layer, a single-layer product was obtained by stacking such that the formation was in the order of the solid electrolyte layer, the positive electrode current collector layer, the positive electrode active material layer, the solid electrolyte layer, the negative electrode active material layer, the negative electrode current collector layer, and the solid electrolyte layer. At this time, the units were each stacked so as not to match each other such that the positive electrode current collector layer of the positive electrode layer unit extended only to one edge surface, and the negative electrode current collector layer of the negative electrode layer unit extended only to the other edge surface. Thereafter, this was formed by thermal compression bonding, and then cut to produce the laminate.

(Production of Sintered Body)

After the obtained laminate was subjected to debinding, co-firing was performed to obtain a sintered body. For the debinding, the temperature was raised to the firing temperature of 700° C. at 50° C./hour in nitrogen, and this temperature was maintained for 10 hours; and for the co-firing, the temperature was raised to the firing temperature of 850° C. at the temperature rising rate of 200° C./hour in nitrogen, this temperature was maintained for 1 hour, and natural cooling was performed after the firing.

Furthermore, it was confirmed that the residual carbon content in the electrode active material layer region of the obtained sintered body was substantially 10 (wt %).

(Production of Terminal Electrodes)

The terminal electrode paste was applied to the edge surface of the above-mentioned sintered body, and heat-curing was performed at 150° C. for 30 minutes to form a pair of terminal electrodes. In this manner, an all-solid-state battery was completed.

(Evaluation of G-Band Full-Width at Half-Maximum (G-FWHM) of Raman Spectrum of Carbon Particles in Electrode Active Material Layers)

The electrode active material layer region of the obtained sintered body was exposed by polishing or the like and processed smoothly, and using a micro-laser Raman spectrometer (device name: NRS-7100, manufactured by JASCO Corporation), the Raman spectrum was measured to calculate from the full-width at half-maximum of the peak appearing near 1580 cm⁻¹ at the excitation wavelength of 532 nm.

(Evaluation of Major Axis a and Minor Axis b of Carbon Particles in Electrode Active Materials)

The electrode active material layer region of the obtained sintered body was exposed by polishing or the like and processed smoothly, and for about 100 or more particles in the visual field from the observation with a scanning electron microscope (SEM), the length in the longest axial direction was defined as a, and the length in the shortest axial direction thereof was defined as b, and thereby the ratio thereof could be calculated as the a/b. For magnification in the SEM, magnification was selected by selecting an appropriate value according to the particle size of the carbon particles such that 100 or more and 300 or less particles were observed in the visual field. The a/b of the carbon particles was calculated as the average of the a/b of all the carbon particles in the visual field.

(Evaluation of Particle Size Distribution of Carbon Particles in Electrode Active

Materials) The electrode active material layer region of the obtained sintered body was exposed by polishing or the like and processed smoothly, and for about 200 or more particles in the visual field from the observation with a scanning electron microscope (SEM), the area of each particle was measured using image processing. The circle-equivalent diameter was calculated from the area data to define the particle size at a cumulative volume of 10% by volume as D10, and define the particle size at a cumulative volume of 90% by volume as D90.

(Evaluation of Carbon Content in Electrode Active Materials)

The electrode active material layer region of the obtained sintered body was separated and pulverized to measure using a combustion in oxygen stream-infrared absorption method with a Carbon Sulfur Analyzer (manufactured by LECO Japan Corporation, device name: CS-844) as an analyzer.

(Measurement of Relative Density)

The external dimensions of the obtained sintered body were measured to calculate the volume, and the weight of the sintered body was divided by the volume to obtain the density of the sintered body. Meanwhile, the ratio of the density of the sintered body, which was obtained after calculating the theoretical density of the shape and dimensions thereof, and the theoretical density was taken as the relative density.

(Evaluation of Impedance)

The obtained laminate was installed to a holding device of a type fixing with a spring attachment pin to measure the internal resistance thereof using an Impedance/Gain-Phase analyzer. The measurement was performed at the measurement frequency of 0.005 Hz, and the alternating current applied voltage of 0.05 V. The values of the obtained internal resistance are shown in Table 2. The case in which the value of the internal resistance was smaller than 1×10⁷ (Ω) was regarded as being favorable.

(Evaluation of Charge and Discharge Characteristics)

Furthermore, the obtained laminate was installed to a holding device of a type fixing with a spring attachment pin to measure the charge and discharge capacity using a charge and discharge tester. The measurement was performed at the current at the time of charging and discharging of 2 μA in all the cases, and the voltage of 0 V to 1.6 V as the measurement conditions. Table 2 shows the measured discharge capacities.

As can be found also from Table 2, it was found that the all-solid-state battery, in which the carbon materials having the a/b in the range according to the present invention were respectively used for the positive electrode active material layer and the negative electrode active material layer, showed a clearly low internal resistance. Furthermore, it was found that when the value of the a/b was in the range of 1.1 to 100.0, a favorable discharge capacity was obtained while showing lower internal resistance. Furthermore, it was found that when the value of the a/b was in the range of 1.5 to 5.0, a better discharge capacity was obtained while showing lower internal resistance.

TABLE 2

| | | | | | Charged | | | | |
|---|---|---|---|---|---|---|---|---|---|
| | G- | | | | addition | Residual | | Discharge | Relative |
| | FWHM | D10 | D90 | a/b | amount | content | Imp (Ω) at | capacity | density |
| | (cm⁻¹) | (μm) | (μm) | ratio | (Wt %) | (Wt %) | 0.005 Hz | (μAh) | (%) |
| Example 5 | 18 | 0.25 | 4.5 | 1.0 | 11.3 | 10 | 9.53 × 10⁶ | 1.25 | 93.75 |
| Example 6 | 18 | 0.25 | 4.5 | 1.1 | 11.3 | 10 | 4.86 × 10⁶ | 3.05 | 95.20 |
| Example 7 | 18 | 0.25 | 4.5 | 1.5 | 11.3 | 10 | 2.00 × 10⁶ | 5.98 | 96.17 |
| Example 2 | 18 | 0.25 | 4.5 | 3.0 | 11.3 | 10 | 5.15 × 10⁵ | 8.15 | 96.65 |
| Example 8 | 18 | 0.25 | 4.5 | 5.0 | 11.3 | 10 | 1.99 × 10⁶ | 4.53 | 95.68 |
| Example 9 | 18 | 0.25 | 4.5 | 10.0 | 11.3 | 10 | 3.81 × 10⁶ | 3.83 | 94.72 |
| Example 10 | 18 | 0.25 | 4.5 | 50.0 | 11.3 | 10 | 6.00 × 10⁶ | 2.25 | 91.82 |
| Example 11 | 18 | 0.25 | 4.5 | 100.0 | 11.3 | 10 | 6.90 × 10⁶ | 2.15 | 89.88 |
| Example 12 | 18 | 0.25 | 4.5 | 200.0 | 11.3 | 10 | 9.21 × 10⁶ | 1.35 | 87.95 |

### Examples 13 to 15

(Mixing of Active Material and Carbon Material)

As Examples 13 to 15, carbon materials in which G-FWHM was 18 (cm⁻¹), the a/b was 3, D10 was 0.1 μm and D90 was 5 μm (Example 13), D10 was 0.2 μm and D90 was 5.5 μm (Example 14), and D10 was 0.08 μm and D90 was 4.0 μm (Example 15) were used to verify the effect of the present embodiment. Furthermore, the above-mentioned Li₃V₂(PO₄)₃ powder was used as an active material. The carbon material was weighed so that it was 11.3 wt % with respect to Li₃V₂(PO₄)₃, and mixing was performed in an organic solvent using a ball mill. The powder was separated from the balls and the organic solvent and dried to obtain a mixed powder of the carbon material and Li₃V₂(PO₄)₃

(Production of Paste for Positive Electrode Active Material Layer and Paste for Negative Electrode Active Material Layer)

For pastes for positive and negative electrode active material layers, 15 parts of ethyl cellulose as a binder and 65 parts of dihydroterpineol as a solvent were added to 100 parts of the above-mentioned mixed powder of the carbon material and Li₃V₂(PO₄)₃, and the mixture was kneaded and dispersed with three rolls to produce pastes for active material layers serving as a positive electrode and a negative electrode.

(Production of Paste for Solid Electrolyte Layer)

As a solid electrolyte, the above-mentioned Li_{1.3}Al_{0.3}Ti_{1.7}(PO₄)₃ powder was used. 100 parts of ethanol and 200 parts of toluene as a solvent were added to 100 parts of this powder by a ball mill to perform wet-type mixing. Thereafter, 16 parts of a polyvinyl butyral-based binder and 4.8 parts of benzyl butyl phthalate were further injected and mixed to compound a paste for a solid electrolyte layer.

(Production of Sheet for Solid Electrolyte Layer)

This paste for a solid electrolyte layer was sheet-formed using a PET film as a substrate by a doctor blade method to obtain a sheet for a solid electrolyte layer having a thickness of 15 μm.

(Production of Paste for Positive Electrode Current Collector Layer and Paste for Negative Electrode Current Collector Layer)

After mixing a Cu powder and a Li₃V₂(PO₄)₃ powder such that the weight ratio was 100:9, 10 parts of ethyl cellulose as a binder and 50 parts of dihydroterpineol as a solvent were added, and mixed and dispersed with three rolls to produce a paste for a positive electrode current collector layer and a paste for a negative electrode current collector layer.

(Production of Terminal Electrode Paste)

A silver powder, an epoxy resin, and a solvent were mixed and dispersed to produce a heat-curable type terminal electrode paste.

(Production of Active Material Layer Unit)

The paste for a positive electrode current collector layer was printed on the above-mentioned sheet for a solid electrolyte layer to the thickness of 5 μm by screen printing, and dried at 80° C. for 10 minutes. The paste for a positive electrode active material layer was printed thereon to the thickness of 5 μm by screen printing, and dried at 80° C. for 10 minutes to obtain a positive electrode layer unit. Meanwhile, the paste for a negative electrode active material layer was printed on the sheet for a solid electrolyte layer to the thickness of 5 μm by screen printing, and dried at 80° C. for 10 minutes, and subsequently, the paste for an negative electrode current collector layer was printed thereon to the thickness of 5 μm by screen printing, and dried at 80° C. for 10 minutes to obtain a negative electrode layer unit. Subsequently, the PET film was peeled off.

(Production of Laminate)

Using the positive electrode layer unit, the negative electrode layer unit, and the sheet for a solid electrolyte layer, a single-layer product was obtained by stacking such that the formation was in the order of the solid electrolyte layer, the positive electrode current collector layer, the positive electrode active material layer, the solid electrolyte layer, the negative electrode active material layer, the negative electrode current collector layer, and the solid electrolyte layer. At this time, the units were each stacked so as not to match each other such that the positive electrode current collector layer of the positive electrode layer unit extended only to one edge surface, and the negative electrode current collector layer of the negative electrode layer unit extended only to the other edge surface. Thereafter, this was formed by thermal compression bonding, and then cut to produce the laminate.

(Production of Sintered Body)

After the obtained laminate was subjected to debinding, co-firing was performed to obtain a sintered body. For the debinding, the temperature was raised to the firing temperature of 700° C. at 50° C./hour in nitrogen, and this temperature was maintained for 10 hours; and for the co-firing, the temperature was raised to the firing temperature of 850° C. at the temperature rising rate of 200° C./hour in nitrogen, this temperature was maintained for 1 hour, and natural cooling was performed after the firing.

Furthermore, it was confirmed that the residual carbon content in the electrode active material layer region of the obtained sintered body was substantially 10 (wt %).

(Production of Terminal Electrodes)

The terminal electrode paste was applied to the edge surface of the above-mentioned sintered body, and heat-curing was performed at 150° C. for 30 minutes to form a pair of terminal electrodes. In this manner, an all-solid-state battery was completed.

(Evaluation of G-Band Full-Width at Half-Maximum (G-FWHM) of Raman Spectrum of Carbon Particles in Electrode Active Material Layers)

The electrode active material layer region of the obtained sintered body was exposed by polishing or the like and processed smoothly, and using a micro-laser Raman spectrometer (device name: NRS-7100, manufactured by JASCO Corporation), the Raman spectrum was measured to calculate from the full-width at half-maximum of the peak appearing near 1580 cm⁻¹ at the excitation wavelength of 532 nm.

(Evaluation of Major Axis a and Minor Axis b of Carbon Particles in Electrode Active Materials)

The electrode active material layer region of the obtained sintered body was exposed by polishing or the like and processed smoothly, and for about 100 or more particles in the visual field from the observation with a scanning electron microscope (SEM), the length in the longest axial direction was defined as a, and the length in the shortest axial direction thereof was defined as b, and thereby the ratio thereof could be calculated as the a/b. For magnification in the SEM, magnification was selected by selecting an appropriate value according to the particle size of the carbon particles such that 100 or more and 300 or less particles were observed in the visual field. The a/b of the carbon particles was calculated as the average of the a/b of all the carbon particles in the visual field.

(Evaluation of Particle Size Distribution of Carbon Particles in Electrode Active Materials)

The electrode active material layer region of the obtained sintered body was exposed by polishing or the like and processed smoothly, and for about 200 or more particles in the visual field from the observation with a scanning electron microscope (SEM), the area of each particle was measured using image processing. The circle-equivalent diameter was calculated from the area data to define the particle size at a cumulative volume of 10% by volume as D10, and define the particle size at a cumulative volume of 90% by volume as D90.

(Evaluation of Carbon Content in Electrode Active Materials)

The electrode active material layer region of the obtained sintered body was separated and pulverized to measure using a combustion in oxygen stream-infrared absorption method with a Carbon Sulfur Analyzer (manufactured by LECO Japan Corporation, device name: CS-844) as an analyzer.

(Measurement of Relative Density)

The external dimensions of the obtained sintered body were measured to calculate the volume, and the weight of the sintered body was divided by the volume to obtain the density of the sintered body. Meanwhile, the ratio of the density of the sintered body, which was obtained after calculating the theoretical density of the shape and dimensions thereof, and the theoretical density was taken as the relative density.

(Evaluation of Impedance)

The obtained laminate was installed to a holding device of a type fixing with a spring attachment pin to measure the internal resistance thereof using an Impedance/Gain-Phase analyzer. The measurement was performed at the measurement frequency of 0.005 Hz, and the alternating current applied voltage of 0.05 V. The values of the obtained internal resistance are shown in Table 3. The case in which the value of the internal resistance was smaller than 1×10⁷ (Ω) was regarded as being favorable.

(Evaluation of Charge and Discharge Characteristics)

Furthermore, the obtained laminate was installed to a holding device of a type fixing with a spring attachment pin to measure the charge and discharge capacity using a charge and discharge tester. The measurement was performed at the current at the time of charging and discharging of 2 μA in all the cases, and the voltage of 0 V to 1.6 V as the measurement conditions. Table 3 shows the measured discharge capacities. The case in which the value of the discharge characteristic was larger than 1.5 μAh was regarded as being favorable.

As can be found also from Table 3, it was found that the all-solid-state battery, in which the carbon materials having D10 and D90 in the range according to the present invention were respectively used for the positive electrode active material layer and the negative electrode active material layer, showed a clearly low internal resistance. Furthermore, it was found that when D10 was 0.1 μm or more and D90 was 5.0 μm or less, a favorable discharge capacity was obtained while showing lower internal resistance.

TABLE 3

| | | | | | Charged | | | | |
|---|---|---|---|---|---|---|---|---|---|
| | G- | | | | addition | Residual | | Discharge | Relative |
| | FWHM | D10 | D90 | a/b | amount | content | Imp (Ω) at | capacity | density |
| | (cm⁻¹) | (μm) | (μm) | ratio | (Wt %) | (Wt %) | 0.005 Hz | (μAh) | (%) |
| Example 13 | 18 | 0.10 | 5.0 | 3.0 | 11.3 | 10 | 4.93 × 10⁶ | 3.07 | 92.30 |
| Example 2 | 18 | 0.25 | 4.5 | 3.0 | 11.3 | 10 | 5.15 × 10⁵ | 8.15 | 96.65 |
| Example 14 | 18 | 0.20 | 5.5 | 3.0 | 11.3 | 10 | 7.99 × 10⁶ | 1.45 | 94.23 |
| Example 15 | 18 | 0.08 | 4.0 | 3.0 | 11.3 | 10 | 9.95 × 10⁶ | 1.18 | 92.30 |

### Examples 16 to 21

(Mixing of Active Material and Carbon Material)

A carbon material in which G-FWHM was 18 (cm⁻¹), the a/b was 3, and D10 was 0.25 μm and D90 was 4.5 μm was used to verify the effect of the present embodiment. Furthermore, the above-mentioned Li₃V₂(PO₄)₃ powder was used as an active material. In Examples 16 to 21, these carbon materials were weighed so that they were respectively 0.49 wt %, 0.58 wt %, 1.13 wt %, 7.12 wt %, 16.95 wt %, and 18.08 wt % with respect to Li₃V₂(PO₄)₃, and mixing was performed in an organic solvent using a ball mill. The powder was separated from the balls and the organic solvent and dried to obtain a mixed powder of the carbon material and Li₃V₂(PO₄)₃.

(Production of Paste for Positive Electrode Active Material Layer and Paste for Negative Electrode Active Material Layer)

For pastes for positive and negative electrode active material layers, 15 parts of ethyl cellulose as a binder and 65 parts of dihydroterpineol as a solvent were added to 100 parts of the above-mentioned mixed powder of the carbon material and Li₃V₂(PO₄)₃, and the mixture was kneaded and dispersed with three rolls to produce pastes for active material layers serving as a positive electrode and a negative electrode.

(Production of Paste for Solid Electrolyte Layer)

As a solid electrolyte, the above-mentioned Li_{1.3}Al_{0.3}Ti_{1.7}(PO₄)₃ powder was used. 100 parts of ethanol and 200 parts of toluene as a solvent were added to 100 parts of this powder by a ball mill to perform wet-type mixing. Thereafter, 16 parts of a polyvinyl butyral-based binder and 4.8 parts of benzyl butyl phthalate were further injected and mixed to compound a paste for a solid electrolyte layer.

(Production of Sheet for Solid Electrolyte Layer)

This paste for a solid electrolyte layer was sheet-formed using a PET film as a substrate by a doctor blade method to obtain a sheet for a solid electrolyte layer having a thickness of 15 μm.

(Production of Paste for Positive Electrode Current Collector Layer and Paste for Negative Electrode Current Collector Layer)

After mixing a Cu powder and a Li₃V₂(PO₄)₃ powder such that the weight ratio was 100:9, 10 parts of ethyl cellulose as a binder and 50 parts of dihydroterpineol as a solvent were added, and mixed and dispersed with three rolls to produce a paste for a positive electrode current collector layer and a paste for a negative electrode current collector layer.

(Production of Terminal Electrode Paste)

A silver powder, an epoxy resin, and a solvent were mixed and dispersed to produce a heat-curable type terminal electrode paste.

(Production of Active Material Layer Unit)

The paste for a positive electrode current collector layer was printed on the above-mentioned sheet for a solid electrolyte layer to the thickness of 5 μm by screen printing, and dried at 80° C. for 10 minutes. The paste for a positive electrode active material layer was printed thereon to the thickness of 5 μm by screen printing, and dried at 80° C. for 10 minutes to obtain a positive electrode layer unit. Meanwhile, the paste for a negative electrode active material layer was printed on the sheet for a solid electrolyte layer to the thickness of 5 μm by screen printing, and dried at 80° C. for 10 minutes, and subsequently, the paste for an negative electrode current collector layer was printed thereon to the thickness of 5 μm by screen printing, and dried at 80° C. for 10 minutes to obtain a negative electrode layer unit. Subsequently, the PET film was peeled off.

(Production of Laminate)

Using the positive electrode layer unit, the negative electrode layer unit, and the sheet for a solid electrolyte layer, a single-layer product was obtained by stacking such that the formation was in the order of the solid electrolyte layer, the positive electrode current collector layer, the positive electrode active material layer, the solid electrolyte layer, the negative electrode active material layer, the negative electrode current collector layer, and the solid electrolyte layer. At this time, the units were each stacked so as not to match each other such that the positive electrode current collector layer of the positive electrode layer unit extended only to one edge surface, and the negative electrode current collector layer of the negative electrode layer unit extended only to the other edge surface. Thereafter, this was formed by thermal compression bonding, and then cut to produce the laminate.

(Production of Sintered Body)

After the obtained laminate was subjected to debinding, co-firing was performed to obtain a sintered body. For the debinding, the temperature was raised to the firing temperature of 700° C. at 50° C./hour in nitrogen, and this temperature was maintained for 10 hours; and for the co-firing, the temperature was raised to the firing temperature of 850° C. at the temperature rising rate of 200° C./hour in nitrogen, this temperature was maintained for 1 hour, and natural cooling was performed after the firing.

Furthermore, it was confirmed that the residual carbon contents in the electrode active material layer region of the obtained sintered body were respectively 0.43, 0.51, 1.00, 6.30, 15.00, and 16.00 (wt %).

(Production of Terminal Electrodes)

The terminal electrode paste was applied to the edge surface of the above-mentioned sintered body, and heat-curing was performed at 150° C. for 30 minutes to form a pair of terminal electrodes. In this manner, an all-solid-state battery was completed.

(Evaluation of G-Band Full-Width at Half-Maximum (G-FWHM) of Raman Spectrum of Carbon Particles in Electrode Active Material Layers)

The electrode active material layer region of the obtained sintered body was exposed by polishing or the like and processed smoothly, and using a micro-laser Raman spectrometer (device name: NRS-7100 (manufactured by JASCO Corporation), the Raman spectrum was measured to calculate from the full-width at half-maximum of the peak appearing near 1580 cm⁻¹ at the excitation wavelength of 532 nm.

(Evaluation of Major Axis a and Minor Axis b of Carbon Particles in Electrode Active Materials)

The electrode active material layer region of the obtained sintered body was exposed by polishing or the like and processed smoothly, and for about 100 or more particles in the visual field from the observation with a scanning electron microscope (SEM), the length in the longest axial direction was defined as a, and the length in the shortest axial direction thereof was defined as b, and thereby the ratio thereof could be calculated as the a/b. For magnification in the SEM, magnification was selected by selecting an appropriate value according to the particle size of the carbon particles such that 100 or more and 300 or less particles were observed in the visual field. The a/b of the carbon particles was calculated as the average of the a/b of all the carbon particles in the visual field.

(Evaluation of Particle Size Distribution of Carbon Particles in Electrode Active Materials)

The electrode active material layer region of the obtained sintered body was exposed by polishing or the like and processed smoothly, and for about 200 or more particles in the visual field from the observation with a scanning electron microscope (SEM), the area of each particle was measured using image processing. The circle-equivalent diameter was calculated from the area data to define the particle size at a cumulative volume of 10% by volume as D10, and define the particle size at a cumulative volume of 90% by volume as D90.

(Evaluation of Carbon Content in Electrode Active Materials)

The electrode active material layer region of the obtained sintered body was separated and pulverized to measure using a combustion in oxygen stream-infrared absorption method with a Carbon Sulfur Analyzer (manufactured by LECO Japan Corporation, device name: CS-844) as an analyzer.

(Measurement of Relative Density)

The external dimensions of the obtained sintered body were measured to calculate the volume, and the weight of the sintered body was divided by the volume to obtain the density of the sintered body. Meanwhile, the ratio of the density of the sintered body, which was obtained after calculating the theoretical density of the shape and dimensions thereof, and the theoretical density was taken as the relative density.

(Evaluation of Impedance)

The obtained laminate was installed to a holding device of a type fixing with a spring attachment pin to measure the internal resistance thereof using an Impedance/Gain-Phase analyzer. The measurement was performed at the measurement frequency of 0.005 Hz, and the alternating current applied voltage of 0.05 V. The values of the obtained internal resistance are shown in Table 4. The case in which the value of the internal resistance was smaller than 1×10⁷ (Ω) was regarded as being favorable.

(Evaluation of Charge and Discharge Characteristics)

Furthermore, the obtained laminate was installed to a holding device of a type fixing with a spring attachment pin to measure the charge and discharge capacity using a charge and discharge tester. The measurement was performed at the current at the time of charging and discharging of 2 μA in all the cases, and the voltage of 0 V to 1.6 V as the measurement conditions. Table 4 shows the measured discharge capacities. The case in which the value of the discharge characteristic was larger than 1.5 μAh was regarded as being favorable.

As can be found also from Table 4, it was found that in the all-solid-state battery, in which the carbon materials having the contents in the range according to the present invention were respectively used for the positive electrode active material layer and the negative electrode active material layer, a clearly densified sintered body was obtained, and a low internal resistance was shown. Furthermore, it was found that when the content of the carbon particles was 0.5 (wt %) or more and 15.0 (wt %) or less, a favorable discharge capacity was obtained while showing lower internal resistance. Furthermore, it was found that when the content of the carbon particles was 1.00 (wt %) or more and 15.0 (wt %) or less, a better discharge capacity was obtained while showing lower internal resistance.

TABLE 4

| | | | | | Charged | | | | |
|---|---|---|---|---|---|---|---|---|---|
| | G- | | | | addition | Residual | | Discharge | Relative |
| | FWHM | D10 | D90 | a/b | amount | content | Imp (Ω) at | capacity | density |
| | (cm⁻¹) | (μm) | (μm) | ratio | (Wt %) | (Wt %) | 0.005 Hz | (μAh) | (%) |
| Example 16 | 18 | 0.25 | 4.5 | 3.0 | 0.49 | 0.43 | 9.75 × 10⁶ | 1.42 | 99.13 |
| Example 17 | 18 | 0.25 | 4.5 | 3.0 | 0.58 | 0.51 | 4.58 × 10⁶ | 2.87 | 98.80 |
| Example 18 | 18 | 0.25 | 4.5 | 3.0 | 1.13 | 1.00 | 9.94 × 10⁵ | 4.57 | 98.54 |
| Example 19 | 18 | 0.25 | 4.5 | 3.0 | 7.12 | 6.30 | 6.87 × 10⁵ | 6.97 | 98.01 |
| Example 2 | 18 | 0.25 | 4.5 | 3.0 | 11.30 | 10.00 | 5.15 × 10⁵ | 8.15 | 96.65 |
| Example 20 | 18 | 0.25 | 4.5 | 3.0 | 16.95 | 15.00 | 1.33 × 10⁶ | 3.81 | 91.25 |
| Example 21 | 18 | 0.25 | 4.5 | 3.0 | 18.08 | 16.00 | 1.35 × 10⁶ | 1.48 | 87.50 |

As described above, the all-solid-state battery according to the present invention is effective in reducing the internal resistance.

### REFERENCE SIGNS LIST

1 Positive electrode layer
2 Negative electrode layer
3 Solid electrolyte layer
4 Laminate
5, 6 Terminal electrode
10 All-solid-state battery

1. An all-solid-state battery comprising:
a positive electrode layer that has a positive electrode current collector layer and a positive electrode active material layer;
a negative electrode layer that has a negative electrode current collector layer and a negative electrode active material layer; and
a solid electrolyte layer that contains a solid electrolyte,
wherein the positive electrode active material layer and the negative electrode active material layer each contain carbon particles in which a G-band full-width at half-maximum (G-FWHM) in a Raman spectrum is 40 (m⁻¹) or less.

2. The all-solid-state battery according to claim 1, wherein when length of a major axis of the carbon particles is a and a minor axis thereof is b, a ratio thereof is 1.0<a/b.

3. The all-solid-state battery according to claim 1, wherein in a particle size distribution of the carbon particles, D10 is 0.1 μm or more, and D90 is 5.0 μm or less.

4. The all-solid-state battery according to claim 1, wherein the positive electrode active material layer and the negative electrode active material layer each contain 0.5 (wt %) or more and 15.0 (wt %) or less of the carbon particles.
